(19) United States
(12) Patent Application Publication
(10) Pub. No.: US 2011/0228574 A1
(43) Pub. Date: Sep. 22, 2011

(54) EMI REDUCTION CIRCUIT FOR ACTIVE PFC CONVERTER

(75) Inventors: Yunpeng Shi, Shanghai (CN); Daming Wu, Shanghai (CN); Baochang Li, Shanghai (CN)

(73) Assignee: KONINKLIJKE PHILIPS ELECTRONICS N.V., EINDHOVEN (NL)

(21) Appl. No.: 13/132,209

(22) PCT Filed: Nov. 26, 2009
(86) PCT No.: PCT/IB2009/055344

§ 371 Date: Jun. 1, 2011

(30) Foreign Application Priority Data
Dec. 1, 2008 (CN) 200810178789.4

(51) Int. Cl. H02M 1/44; H02M 1/42

(52) U.S. Cl. 363/42

(57) ABSTRACT

The present invention provides a technical solution to reduce electromagnetic interference generated by a high-frequency switching electronic circuit. By adding a disturbance signal whose amplitude varies with time to the input pin of the active power factor correction module of the high frequency switching electronic circuit which is intended to receive an input power control signal, the switching frequency of the active power factor correction module varies with time, so that the electromagnetic interference energy is dispersed in a frequency domain and the electromagnetic interference is reduced. While the effect is even more apparent particularly when the power supply of the high-frequency switching electronic circuit is a DC power source.

### FIELD OF THE INVENTION

The present invention relates to electromagnetic interference suppression, particularly to electromagnetic interference suppression of a high-frequency switching electronic circuit.

### BACKGROUND OF THE INVENTION

Currently, electronic ballasts in emergency lighting installations are indispensable. In normal situations, the power supply for the emergency lighting installation is an AC power source; in emergency situations, such as fire, the power supply for the emergency lighting installation is a DC power source. In accordance with new requirements imposed on electronic ballasts, the electromagnetic interference generated by these electronic ballasts must comply with predefined standards so as to be suitable for emergency illumination in circumstances in which the power supply is a DC power source and an AC power source. Electromagnetic interference (EMI) refers to an electromagnetic phenomenon of electromagnetic waves leading to a decrease in performance of devices, transmission channels or systems.

When an electronic ballast using an active power factor correction module is powered by an AC power source, the energy of its generated EMI corresponds to the standard CISPR15. However, when it is powered by a DC power source, the EMI energy is concentrated at certain frequency points and exceeds the limit value of the standard CISPR15.

### SUMMARY OF THE INVENTION

To solve the above-mentioned problem in the prior art, an embodiment of the present invention provides a technical solution to reduce EMI generated by a high-frequency switching electronic circuit having an active power factor correction module, particularly by electronic ballasts. An embodiment of the present invention provides a method of reducing EMI generated by a high-frequency switching electronic circuit comprising an active power factor correction module, wherein the method comprises the steps of: b. generating a disturbance signal whose amplitude varies with time; and c. adding said disturbance signal to an input pin of the active power factor correction module, which pin is intended to receive an input power control signal.

Another embodiment of the present invention provides a suppression circuit for reducing EMI generated by a high-frequency switching electronic circuit comprising an active power factor correction module, wherein said suppression circuit comprises a disturbance signal module configured to generate a disturbance signal whose amplitude varies with time and to add said disturbance signal to an input pin of the active power factor correction module, which pin is intended to receive an input power control signal.

A further embodiment of the present invention provides an electronic ballast. Said electronic ballast comprises the above-mentioned suppression circuit.

Yet another embodiment of the present invention provides a high-frequency switching electronic circuit comprising an active power factor correction module, wherein said electronic circuit further comprises a microcontroller which is configured to generate a disturbance signal whose amplitude varies with time and to add said disturbance signal to the input pin of the active power factor correction module, which pin is intended to receive an input power control signal.

The high-frequency switching electronic circuit is herein understood to mean an electronic circuit causing an isolated coupling transformer to realize a high frequency, as well as miniaturization and freedom of noise by using a high-frequency switching technique, such as an active power factor correction boost converter using MOSFET as a switching device, abbreviated as active power factor correction module.

By adding a disturbance signal whose amplitude varies with time to the input pin of the active power factor correction module of the high frequency switching electronic circuit, which pin is intended to receive an input power control signal, the switching frequency of the active power factor correction module consequently varies with time, so that the EMI energy is dispersed in a frequency domain and the EMI interference is reduced. Consequently, EMI generated by the high frequency switching electronic circuit can be efficiently reduced, while the effect will be even more apparent in circumstances in which the power supply of the high-frequency switching electronic circuit is a direct current.

### BRIEF DESCRIPTION OF THE DRAWINGS

Other objects, features and advantages of the present invention will be apparent from the following description of embodiments, given by way of non-limiting example and described with reference to the accompanying drawings, in which

FIG. 1 illustrates a partial circuit structure of the electronic ballast comprising the suppression circuit, according to an embodiment of the present invention;

FIG. 2 is a work flow chart of the suppression circuit shown in FIG. 1;

FIG. 3 illustrates a voltage waveform of pin MULTI of the power correction factor control circuit, when the power supply of the electronic ballast shown in FIG. 1 is an AC power source;

FIGS. 4(a) and 4(b) illustrate the energy distribution of EMI generated by the circuit shown in FIG. 1 with and without a suppression circuit, respectively, wherein said circuit is powered by a DC power source; and

FIG. 5 illustrates a partial circuit structure of the electronic ballast of the suppression circuit, according to another embodiment of the present invention.

In the drawings, identical or similar reference signs and numerals denote the same or similar steps, features and/or apparatus (modules).

### DESCRIPTION OF EMBODIMENTS

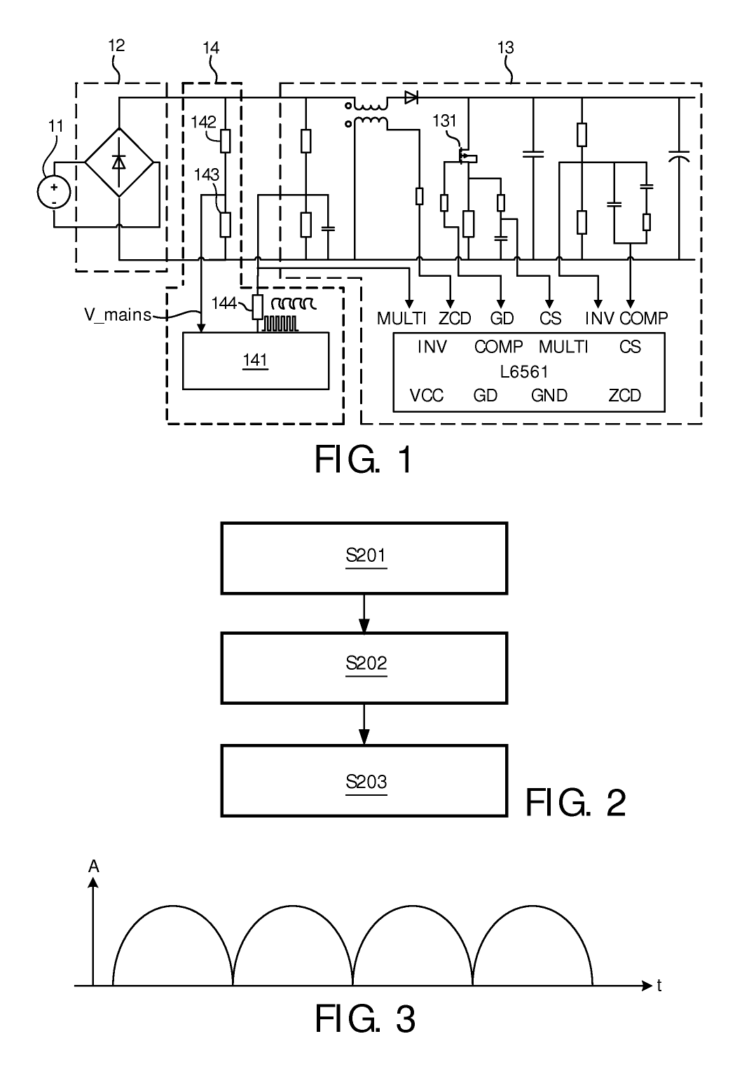

FIG. 1 illustrates a partial circuit structure of the electronic ballast comprising the suppression circuit, according to an embodiment of the present invention. This figure comprises schematic views of a power source 11, a half-bridge rectifier circuit 12, an active power factor correction module 13 and an example of a suppression circuit 14. The active power factor correction module 13 is based on the principle of peak value detection and comprises a main circuit and a control circuit. The control circuit is realized by the chip L6561 provided by STMicroelectronics.

Since the present invention mainly relates to an improvement of the active power factor correction module 13, a further description of other necessary components of an electronic ballast such as an inverter circuit, an output network, etc. will be dispensed with because these components have no direct relationship with the present invention. Details of those other necessary components are described in e.g. reference document 1: “Principle and Design of new type Electronic Ballast Circuits” (M A O Xingwu, Z H U Dawei, Posts & Telecom Press, September 2007).

As compared with existing electronic ballast circuits, the circuit shown in the dashed line frame 14 of FIG. 1 is a newly added EMI suppression circuit comprising a microcontroller 141, a current-limiting resistor 144 and resistors 142 and 143. Resistors 142 and 143 constitute a sampling module for sampling a waveform signal V_mains of the power supply of the electronic ballast and for providing the waveform signal V_mains to the microcontroller 141.

FIG. 2 is a work flow chart of the suppression circuit shown in FIG. l. The steps shown in FIG. 2 will now be elucidated in detail with reference to FIG. 1.

First, in step S201, the microcontroller 141 determines whether the power supply of the electronic ballast is a DC power source. With reference to the suppression circuit shown in FIG. 1, the microcontroller 141 concretely determines whether the power supply of the electronic ballast is a DC power source by means of the waveform of the signal V_mains which is sampled from the node between the sampling resistors 142 and 143. If the power supply is an AC power source, the waveform of the signal V_mains, after going through the bridge rectifier circuit, should be half sinusoidal as shown in FIG. 3. The amplitude of the waveforms will of course be different due to different resistances of the sampling resistors. If the power supply is a DC power source, the waveform of the signal V_mains, after going through the bridge rectifier circuit, should be a straight line, namely, its amplitude does not change with time.

If, in step S201, the microcontroller 141 determines that the power supply of the electronic ballast is a DC power source, the microcontroller 141 will generate, in step S202, a disturbance signal whose amplitude varies with time.

Subsequently, in step S203, the microcontroller 141 adds the disturbance signal to an input pin of the active power factor correction module 13 of the electronic ballast, which pin is intended to receive an input power control signal. For the circuit structure shown in FIG. 1, the disturbance signal is added to the pin MULTI through the current-limiting resistor 144. Originally, the switching frequency of MOSFET 131 does not vary with time under the situation that the ballast is powered by a DC power source. With the effect of the disturbance signal whose amplitude varies with time on the switching frequency of MOSFET 131, the switching frequency of MOSFET 131 varies with time, so that the distribution of EMI energy originally caused by the fixed switching frequency of MOSFET 131 is dispersed in a frequency domain, which decreases the intensity of EMI.

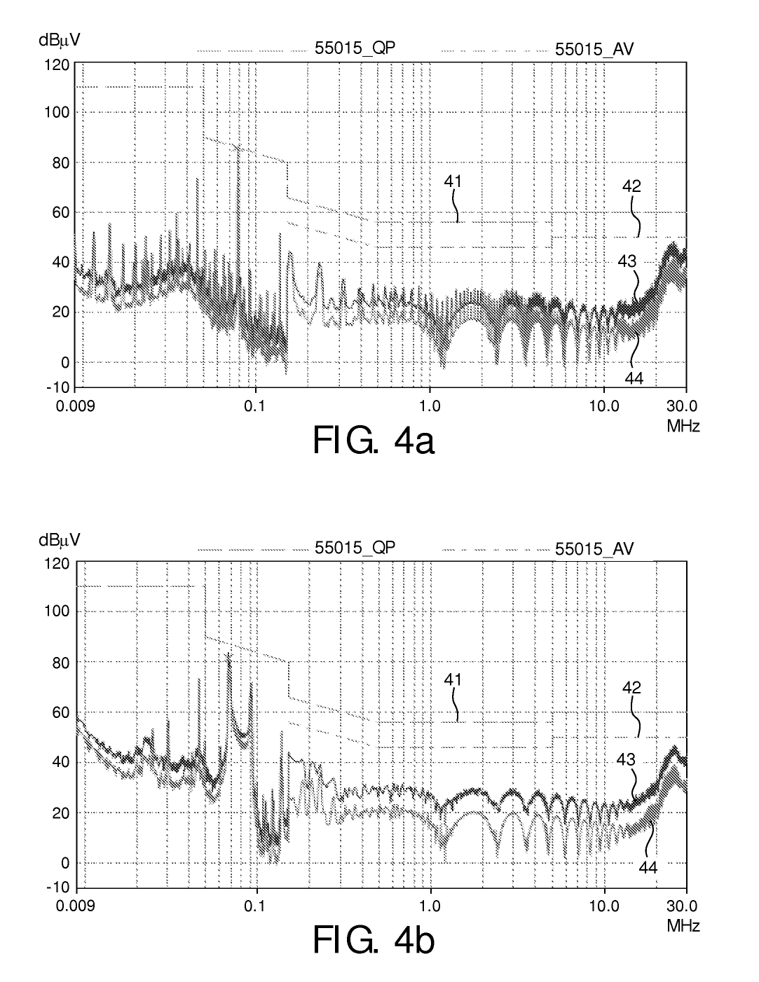

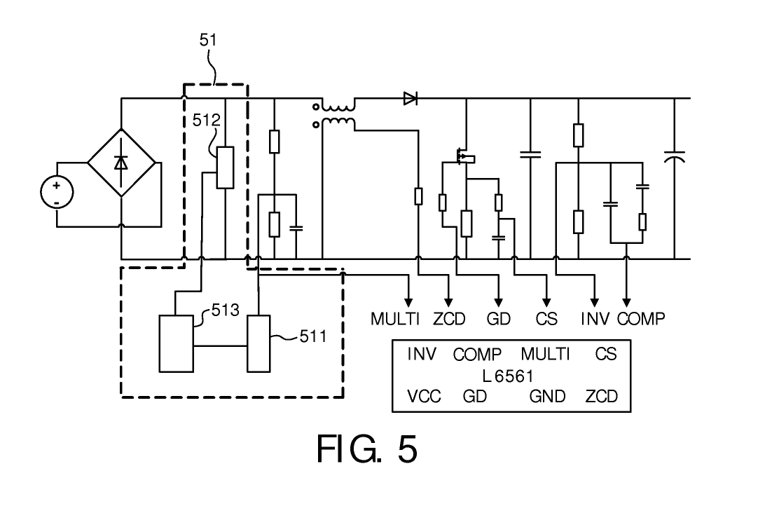

FIGS. 4(a) and 4(b) illustrate the energy distribution of EMI generated by the circuit shown in FIG. 1 with and without the suppression circuit 14, respectively, wherein said circuit is powered by a 230V DC power source. In the circuit shown in FIG. 4(b), the microcontroller 141 first generates a 100 MHz square wave with 50% duty cycle, and then transforms the square wave to a ripple which is then added to pin MULTI.

In FIGS. 4(a) and FIG. 4(b), the broken line 41 denotes the limit value of the Quasi Peak (QP) value of EMI energy in the standard CISPR15, the broken line 42 denotes the limit value of the average value of the EMI energy in the standard CISPR15, the curve 43 denotes the QP value of EMI energy generated by the electronic ballast, and the curve 44 denotes the average value of EMI energy generated by the electronic ballast.

As can be seen from FIG. 4(a), the QP value of EMI energy received by the electromagnetic radiation receiver is 85.82 dB μV at the frequency point 77.5 KHz, and the limit value provided in the standard CISPR15 is 86.01 dB μV, i.e. their difference is only 0.19 dB μV. In FIG. 4(b), the QP value of EMI energy received by the electromagnetic radiation receiver is 55 dB μV at the frequency point 77.5 KHz. In FIG. 4(b), the largest interference is at the frequency point 67.72 KHz, the QP value of EMI energy received by the electromagnetic radiation receiver is 81.57 dB μV, and the limit value in the standard CISPR15 is 87.24 dB μV, i.e. their difference is 5.67 dB μV. It can be seen that the EMI energy generated by the electronic ballast, particularly energy at certain frequency points, is efficiently reduced by using the suppression method and circuit of the present invention.

It should be noted that the structure of the suppression circuit shown in FIG. 1 is only an example. In practice, various modifications can be made on the basis of the circuit structure shown in FIG. 1. For example, the location of the sampling resistors 142 and 143 in the whole ballast circuit is not limited but can be located at any position as long as the microcontroller 141 can determine whether the power supply of the electronic ballast is a DC or an AC power source. The resistors 142 and 143 can also be connected between the power supply and the bridge rectifier circuit. Furthermore, the resistors 142 and 143 may consist of one or more resistors, respectively. Alternatively, as a variant of the sampling module consisting of the resistors 142 and 143 shown in FIG. 1, the pin V_mains of the microcontroller 141 can also be directly connected to the pin MULTI which is the input pin of the active power factor correction module, which pin is intended to receive an input power control signal, namely, a single conducting wire carries out the sampling function.

In the flow chart shown in FIG. 2, step S201 is not a necessary step of the present invention, while the microcontroller neither needs to determine whether the power supply of the electronic ballast is a DC or an AC power source. In fact, no matter whether the power supply is a DC or an AC power source, the microcontroller 141 adds the disturbance signal to the pin MULTI which is the input pin of the active power factor correction module, which pin is intended to receive an input power control signal.

Moreover, also the current-limiting resistor 144 is not indispensable in the present invention. If the current flowing through the output pin of the microcontroller 141 is within the scope allowed by the microcontroller 141, no extra current-limiting resistor is needed. Furthermore, the current-limiting resistor 144 can also be arranged inside the microcontroller 141.

It should be further noted that the frequency and the amplitude of the disturbance signal can be adjusted in accordance with the used parameters of the active power factor correction circuit and the physical environment in practice, and its waveform is neither limited as long as its amplitude varies with time. The waveform may comprise various regular and/or irregular waveforms, such as a square wave, a ripple, a triangular wave, a stepped square wave, etc. The disturbance signal may be a voltage or a current signal, depending on whether a voltage or a current source is used as the power supply for the active power factor correction module.

The method shown in FIG. 2 and the suppression circuit 14 shown in FIG. 1 are applicable for various active power factor correction modules, such as those based on peak value detection, hysteresis loop or the average current principle, etc. The concrete circuits of these active power factor correction modules are described in reference document 1 or 2: “Principle of Power Factor Correction and Control IC and Application Designs thereof” (M A O Xingwu, Z H U Dawei, China electrical power press, November 2007). Furthermore, there are various control circuits for active power factor correction, not limited to L6561 shown in the Figures. Reference can be made to the examples described in reference documents 1 and 2 of various control circuits for the active power factor correction module.

The method shown in FIG. 2 and the suppression circuit 14 shown in FIG. 1 are neither limited to be used for electronic ballast, but are also applicable for other high-frequency switching electronic circuits comprising active power factor correction modules.

FIG. 5 illustrates another circuit structure of the suppression circuit 51 used for reducing EMI generated by the electronic ballast, according to another embodiment of the present invention. The suppression circuit 51 comprises a disturbance signal module 511, a sampling module 512 and a detection module 513. For conciseness, modules of many preferred embodiments are illustrated together in FIG. 5. It will be evident to those skilled in the art that, among all modules, only the disturbance signal module 511 is the necessary module for the suppression circuit of the present invention, whereas the sampling module 512 and the detection module 513 are optional.

In FIG. 5, the disturbance signal module 511 generates a disturbance signal, whose amplitude varies with time, and then adds the disturbance signal to the pin MULTI acting as the input pin of the active power factor correction module of the electronic ballast, which pin is intended to receive an input power control signal. As described above, the frequency and amplitude of the disturbance signal can be adjusted in accordance with the used parameters of the active power factor correction circuit and the physical environment in practice, and its waveform is neither limited as long as its amplitude varies with time. The waveform can be various regular and irregular waveforms, such as a square wave, a ripple, a triangular wave, a stepped square wave, etc. The disturbance signal may be a voltage or a current signal, depending on whether a voltage or a current source is used as the power supply for the active power factor correction module. The function of the disturbance module 511 can be realized by a hardware circuit or in the way in which the microcontroller 141 shown in FIG. 1 executes programs with a corresponding function.

At some time, the disturbance signal module 511 generates the disturbance signal and adds it to the input pin of the active power factor correction module, which pin is intended to receive an input power control signal, only in the circumstance in which the power supply of the electronic ballast is a DC power source. Here, the work flow of the suppression circuit 51 is described as follows.

First, the sampling module 512 samples waveform signal of the power supply of the electronic ballast and provides the waveform signal to the detection module 513. The location of the sampling module 512 in the whole ballast circuit is not limited; it may be located at any position as long as the detection module 513 can determine whether the power supply of the electronic ballast is a DC or an AC power source. For example, the sampling module 512 is connected to the two terminals of the power supply of the electronic ballast or the active power factor correction module shown in FIG. 5. As shown in FIG. 1, the sampling module 512 may comprise two groups of resistors which are serially connected, with the waveform signal being sampled at the common node of the two group resistors. Alternatively, the sampling module consists of only a conducting wire connecting the sampling module with the input pin of the active power factor correction module, which pin is intended to receive an input power control signal, with the waveform signal being sampled at this input pin of the active power factor correction module.

Subsequently, the detection module 513 determines whether the power supply of the electronic ballast is a DC power source by detecting the waveform signal collected by the sampling module 512. There are many methods of determining whether the power supply is a DC power source. A preferred method has been described above in step S201 in FIG. 2. The function of the detection module 513 can be realized by a hardware circuit or in the way in which the microcontroller 141 shown in FIG. 1 executes programs with a corresponding function.

If the detection module 513 determines that the power supply of the electronic ballast is a DC power source, it controls the disturbance signal module 511 to generate the disturbance signal and to add the disturbance signal to the input pin of the active power factor correction module, which pin is intended to receive an input power control signal.

It should be noted that the function of the suppression circuit shown in FIG. 5 can be realized fully by a hardware circuit or by means of a combination of software and hardware. In the suppression circuit shown in FIG. 1, the function of the disturbance signal module 511 and the detection module 513 shown in FIG. 5 can be fully realized in the way in which the microcontroller 141 executes programs with a corresponding function. Alternatively, it can be realized by means of a combination of software and hardware. For example, the suppression circuit shown in FIG. 1 comprises the microcontroller 141, the sampling resistors 142 and 143 and the current-limiting resistor 144.

The suppression circuit shown in FIG. 5 is applicable for various active power factor correction modules, such as those based on peak value detection, hysteresis loop or the average current principle, etc. Furthermore, its scope of application is not limited to be used for electronic ballasts, but is also applicable for high-frequency switching electronic circuits comprising active power factor correction modules.

It will be evident to those skilled in the art that the present invention is not limited to the specific embodiments described hereinbefore and that various modifications can be made without departing from the scope and spirit of the appending claims

1. A method of reducing electromagnetic interference generated by a high-frequency switching electronic circuit comprising an active power factor correction module, wherein the method comprises the steps of:
b): generating a disturbance signal whose amplitude varies with time;
c): adding said disturbance signal to an input pin of the active power factor correction module, which is intended to receive an input power control signal.

2. The method according to claim 1, wherein, prior to step b, the method further comprises step a) of determining whether the power supply of the high-frequency switching electronic circuit is a DC power source; and wherein steps b) and c) will be executed if the power supply of the high-frequency switching electronic circuit is a DC power source.

3. The method according to claim 1, wherein the disturbance signal comprises a voltage signal.

4. The method according to claim 1, wherein the active power factor correction module is based on the peak value detection principle, the hysteresis loop principle or the average current principle.

5. The method according to claim 1, wherein the high-frequency switching electronic circuit comprises an electronic ballast.

6. A suppression circuit for reducing electromagnetic interference generated by a high-frequency switching electronic circuit comprising an active power factor correction module, wherein the suppression circuit comprises:
a disturbance signal module configured to generate a disturbance signal whose amplitude varies with time and to add said disturbance signal to an input pin of the active power factor correction module, which is intended to receive an input power control signal.

7. The suppression circuit according to claim 6, further comprising a sampling module and a detection module, wherein
the sampling module is configured to sample a waveform signal of the power supply of the high-frequency electronic circuit and to provide the waveform signal to the detection module;
the detection module is configured to determine whether the power supply of the high-frequency switching electronic circuit is a DC power source by detecting the waveform signal sampled by the sampling module; and,
if the detection module determines that the power supply of the high-frequency switching electronic circuit is a DC power source, the detection module controls the disturbance signal module to generate a disturbance signal whose amplitude varies with time and to add said disturbance signal to the input pin of the active power factor correction module which is intended to receive an input power control signal.

8. The suppression circuit according to claim 7, wherein the sampling module is coupled between the two terminals of either the power supply of the high-frequency switching electronic circuit or the power supply of the active power factor correction module and comprises two groups of resistors which are serially connected, with the waveform signal being sampled at the common node of the two groups of resistors; or
the sampling module is connected to the input pin of the active power factor correction module which is intended to receive an input power control signal, with the waveform signal being sampled from the input pin of the active power factor correction module which is intended to receive an input power control signal.

9. The suppression circuit according to claim 6, wherein the disturbance signal comprises a voltage signal.

10. The suppression circuit according to claim 6, wherein the active power factor correction module is based on the peak value detection principle, the hysteresis loop principle or the average current principle.

11. An electronic ballast comprising a suppression circuit according to any one of claims 6 to 10.

12. A high-frequency switching electronic circuit comprising an active power factor correction module, wherein said electronic circuit further comprises:
a microcontroller configured to generate a disturbance signal whose amplitude varies with time and to add said disturbance signal to an input pin of the active power factor correction module, which is intended to receive an input power control signal.

13. The high-frequency switching electronic circuit according to claim 12, further comprising:
a sampling module configured to sample a waveform signal of the power supply of the high-frequency switching electronic circuit and to provide said waveform signal to the microcontroller;
the microcontroller being further configured to:
determine, in accordance with said waveform signal provided by the sampling module, whether the power supply of the electronic circuit is a DC power source;
subsequently generate a disturbance signal if the power supply of the electronic circuit is a DC power source and to add said disturbance signal to the input pin of the active power factor correction module which is intended to receive an input power control signal.

14. The high-frequency switching electronic circuit according to claim 13, wherein
the sampling module is coupled between the two terminals of the power supply of the high-frequency switching electronic circuit and comprises two groups of resistors which are serially connected, with the waveform signal being sampled at the common node of the two groups of resistors; or
the sampling module is connected to the input pin of the active power factor correction module which is intended to receive an input power control signal, with the waveform signal being sampled from the input pin of the active power factor correction module which is intended to receive an input power control signal.

15. The high-frequency switching electronic circuit according to claim 12, comprising an electronic ballast.
